(19) United States
(12) Patent Application Publication
(10) Pub. No.: US 2002/0066839 A1
(43) Pub. Date: Jun. 6, 2002

(54) Vehicle-mounted cargo rack bracket assembly

(76) Inventor: Eric C. Pollack, Ruston, WA (US)

Correspondence Address: Eric C Pollack, 5320 N Bennett, Ruston, WA, 98407, US

(21) Appl. No.: 09/730,243

(22) Filed: Dec. 5, 2000

(51) Int. Cl. B60R 9/06

(52) U.S. Cl. 248/200; 248/205.1; 224/521

(57) ABSTRACT

A pair of brackets (10) that easily attaches to a vehicle either directly or via a hitch system. The brackets (10) are arranged at an angle to each other and to the mounting surface. The two bracket receptacles (10) are arranged relative to each other substantially like the letter ‘V’. Each bracket is a receptacle sized to accept standard structural material (38A) such as cut lumber. The user can mount the device to a vehicle and insert structural material into the receptacles, then top the structure with a horizontally mounted surface (38B), which becomes a cargo-bearing surface.

### CROSS-REFERENCE TO RELATED APPLICATIONS

Not Applicable

### STATEMENT REGARDING FEDERAL RESEARCH AND DEVELOPMENT

Not Applicable

### REFERENCE TO MICROFICHE APPENDIX

Not Applicable

### BACKGROUND FIELD

This invention relates to the field of cargo-carrying devices for external use on motor vehicles.

### BACKGROUND—DISCUSSION OF PRIOR ART

The Problem

All across the world people transport cargo by mounting it on the outside of their cars. This is done in many ways, some of which work better than others. In the USA, one of the more popular devices for holding cargo on the outside of a car is the roof rack. These are versatile racks that are fixed to the roof of the vehicle, providing a location and convenient method of attaching the external cargo. Such racks typically can be outfitted with additional apparatus that facilitates carrying specific equipment. I.E., bicycle and ski attachments are quite common.

One major shortcoming of the ubiquitous roof rack is its inability to handle long cargo loads such as tandem bikes, canoes, and ladders. When installed on sedans, the distance between the rack's front and rear cross bars is often too short to provide the stability required to suitably carry long loads.

One occasionally employed solution to this problem is the use of an additional frame at the rear of the cars. These rear frames are typically quadrilateral figures (rectangular), and are custom made for the individual vehicle and cargo requirements. They are generally comprised of welded box steel and are attached to the car either by being bolted to the car's frame under the bumper or by being plugged into an existing hitch receiver box under the bumper.

Common Solutions

When used with a single roof-mounted cross-bar, these rectangular frames do indeed provide an additional surface on which to mount long cargo. However, they are not without fault. Their drawbacks include:

(a) They are expensive. They are not available in an off-the-shelf format. Consequently, each must be custom-made, requiring the services of a metal shop and associated personnel such as a welder. This makes them more expensive than mass-produced merchandise, and less convenient to acquire.

(b) They are not optimally stable. Because they are rectangular (or otherwise quadrilateral), the frame allows lateral wobble under real-world load and driving conditions. It is well known that rectangles are not an inherently stable form.

(c) They are not exceptionally easy to customize for particular cargo other than the cargo for which the frame was originally designed. This is due to the rack's composition of box-steel. After-market accessories such as bicycle carriers are not made to fit box-steel and steel is not easy to work with due to its durability. This is not a major shortcoming, but may be an issue for some people.

(d) Rectangular steel cargo frames are heavy due to their use of steel.

(e) Steel rectangular cargo frames are not built to be disassembled. It would be preferable if the frame could be dismantled to facilitate stowage inside the vehicle for times when the owner does not desire to have the frame mounted on the outside of the vehicle.

(f) Rectangular steel cargo frames also impair the vehicle's crash worthiness by blocking the body of the vehicle from damage. This may cause an impact to the rear corner of a vehicle fitted with a rectangular steel cargo frames to transfer a larger portion of its energy to the vehicle's passengers, rather than allowing the vehicle's frame to dissipate the impact as it was designed to do. This could make riding in the vehicle more dangerous than it already is.

Another prior-art solution for carrying long cargo consists of a vehicle- or hitch-mounted single vertical bar that is topped with a horizontal load-carrying bar.

Harbor Freight Tool Company offers such a rack device that mounts to a hitch socket and provides a horizontal runner bar leading to a single vertical bar with a single crossbar at the top. It is marketed for use on pick-up trucks to render a rear surface for carrying long cargo. The long horizontal bar that extends away from the hitch allows the truck's gate to be fully opened.

This is a good idea, but it has most of the same drawbacks as does the rectangular steel box frame. Furthermore, it interferes with the line of vision straight back from the vehicle's internal rear-view mirror.

Although there are some solutions for carrying long cargo on vehicles that were not designed for such duty, none of the existing solutions are perfect. There persists a need for a rack device that is inexpensive, stable, customizable, light, durable, easy to dismantle, and safe.

### SUMMARY

I have therefore developed a V-shaped cargo rack bracket assembly that addresses the short-comings of prior-art solutions to the long-cargo problem. My bracket assembly consists of a pair of receptacles that are angled like the letter “V” and are mountable on a vehicle. This bracket assembly provides the base for a complete rack assembly that is inexpensive, stable, customizable, light-weight, durable, easy to dismantle, and safe.

### OBJECTS AND ADVANTAGES

Accordingly, the objects and advantages of the present bracket assembly invention are:

(a) to provide a base for a complete rack assembly that is easy to mount-on and remove from a vehicle.

(b) to provide a base for a complete rack assembly that is inexpensive.

(c) to provide a base for a complete rack assembly that is stable.

(d) to provide a base for a complete rack assembly that is customizable by the user.

(e) to provide a base for a complete rack assembly that is light-weight.

(f) to provide a base for a complete rack assembly that is durable.

(g) to provide a base for a complete rack assembly that is easy to disassemble.

(h) to provide a base for a complete rack assembly that does not appreciably interfere with the safety of the vehicle on which it is mounted.

### DESCRIPTION OF DRAWINGS

FIG. 1 shows the preferred embodiment of the bracket assembly.

FIG. 2 shows a version of the bracket assembly in wherein the bracket receptacles are attached to a common baseplate rather than to each other.

FIGS. 3A and 3B display a version wherein the bracket section is connected to a baseplate with a hinge.

FIG. 4 shows a bracket assembly with a threaded mounting shaft.

FIG. 5 shows a version wherein the bracket assembly is attached to a drawbar.

FIG. 6 shows a version wherein the brackets are attached to a drawbar.

FIG. 7 displays the bracket assembly employed on a vehicle.

FIG. 8 shows the details of how to mount the preferred embodiment to a vehicle's drawbar.

FIGS. 9A and 9B show a bracket assembly with hinges.

List of Reference Numbers Used in Drawings

10 Receptacle (for lumber or other structural material)

12A Standard Flat Mounting Flange

12B Wide Mounting Flange

12C Hinge-compatible Mounting Flange

14 Baseplate

16 Hitchball Shaft Hole

18A Square Drawbar (also known as a towbar)

18B Flat Drawbar (also known as a towbar)

20 Hitch Pin Hole

22 Hitchball

24 Mounting Shaft

26 Threaded Shaft

28 Fastening Nut

30 Hinge

32 Drainage Hole

34 Set-Screw Hole

36 Set-Screw

38 Lumber or other structural material

40 Automotive Vehicle

42 Complete Rack Assembly

### DESCRIPTION OF INVENTION

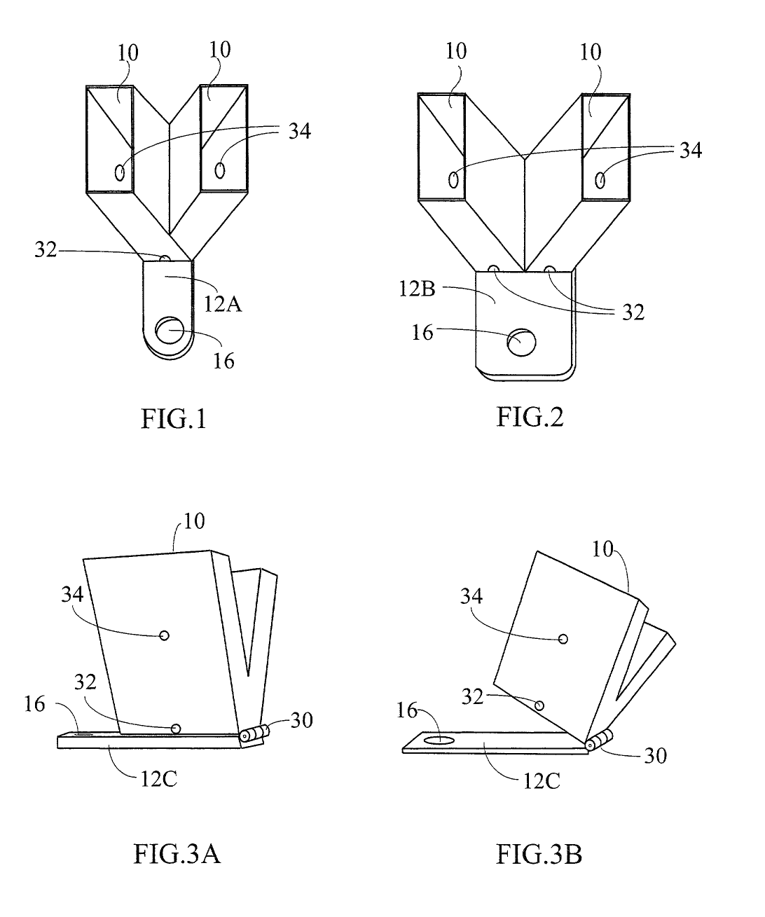

FIG. 1—Preferred Embodiment

Two brackets 10 are connected to each other. The brackets 10 are angled so that they are not parallel to each other. The brackets 10 are connected to a combination baseplate and mounting flange 12A. The flange 12A possesses a mounting shaft hole 16. The brackets 10 possess drainage holes 32 near the flange 12A. The brackets 10 possess set-screw holes 34 near the middle of one side of each bracket 10.

FIG. 2—Additional Embodiment

Two brackets 10 are angled so that they are not parallel to each other. The brackets 10 are connected to a combination baseplate and mounting flange 12B. The flange 12B possesses a mounting shaft hole 16. The brackets 10 possess drainage holes 32 near the flange 12B. The brackets 10 possess set-screw holes 34 near the middle of one side of each bracket 10.

FIGS. 3A and 3B—Additional Embodiment

Two brackets 10 are connected to each other. The brackets 10 are angled so that they are not parallel to each other. The brackets 10 are connected to a hinge 30. The other end of the hinge 30 is connected to a combination baseplate and mounting flange 12C. The flange 12C possesses a mounting shaft hole 16. The brackets 10 possess drainage holes 32 near the flange 12C. The brackets 10 possess set-screw holes 34 near the middle of one side of each bracket 10.

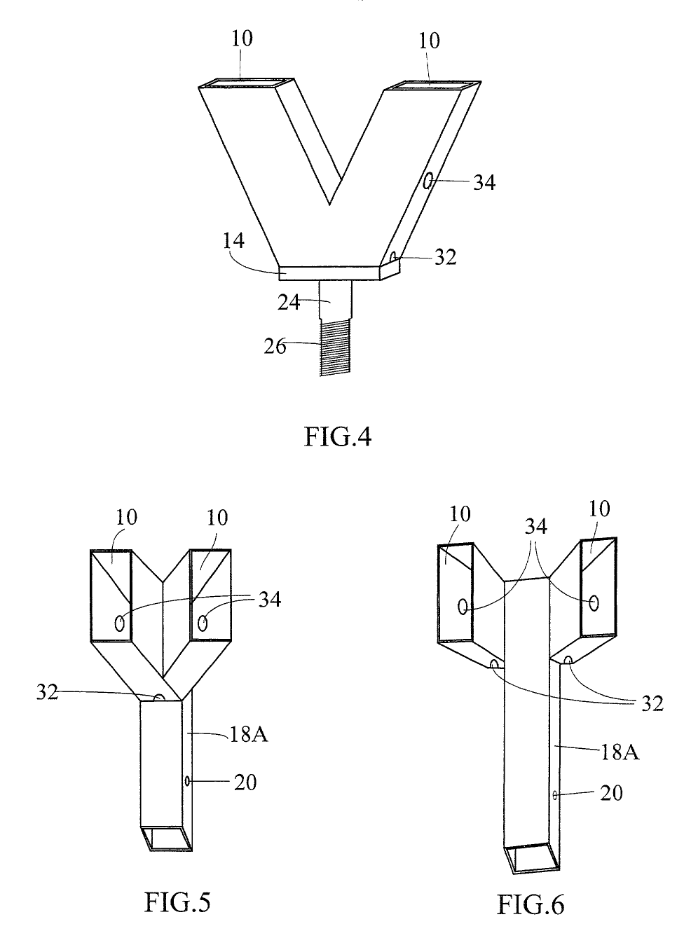

FIG. 4—Additional Embodiment

Two brackets 10 are connected to each other. The brackets 10 are angled so that they are not parallel to each other. The brackets 10 are connected to a baseplate 14. The opposite face of baseplate 14 possesses a mounting shaft 24 that extend away from the baseplate 14. The shaft 24 is partially a threaded shaft 26. The brackets 10 possess drainage holes 32 near the baseplate 14. The brackets 10 possess set-screw holes 34 near the middle of one side of each bracket 10.

FIG. 5—Additional Embodiment Two brackets 10 are connected to each other. The brackets 10 are angled so that they are not parallel to each other. The brackets 10 are connected to a combination baseplate and towbar 18A . The towbar 18A possesses a hitch pin hole 20. The brackets 10 possess drainage holes 32 near the towbar 18A. The brackets 10 possess set-screw holes 34 near the middle of one side of each bracket 10.

FIG. 6—Additional Embodiment Two brackets 10 are angled so that they are not parallel to each other. The brackets 10 are connected to a combination baseplate and towbar 18A . The towbar 18A possesses a hitch pin hole 20. The brackets 10 possess drainage holes 32 near the towbar 18A. The brackets 10 possess set-screw holes 34 near the middle of one side of each bracket 10.

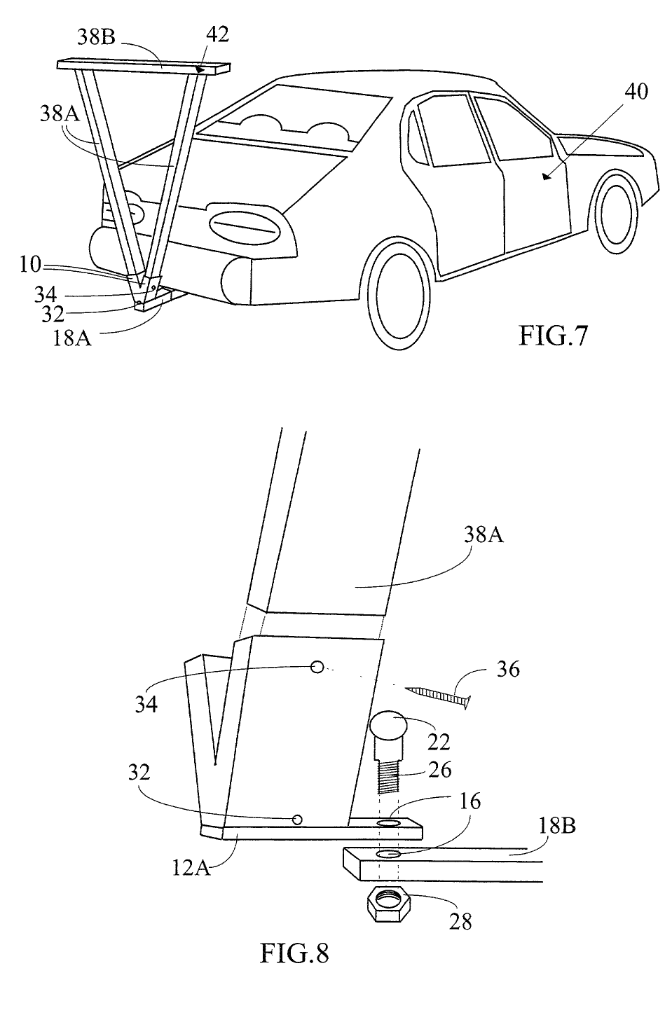

FIG. 7—Overview of fully employed bracket assembly

This shows the implementation of the bracket assembly of FIG. 5. The drawbar 18A of a bracket assembly is inserted into the hitch receiver box of a vehicle 40. a hitch pin is inserted through the hitch receiver box and through the hitch pin hole 20 of the drawbar 18A. This effectively attaches the bracket assembly to the vehicle 40.

Structural material 38A is inserted into both of the brackets 10 of the bracket assembly. Additional structural material 38B is attached to the top ends of the structural material 38A. This creates a completed cargo rack 42 that is firmly attached to the vehicle 40.

FIG. 8—Detail of mounting preferred embodiment to a vehicle's drawbar

This shows the detail of mounting the bracket assembly of FIG. 1.

The mounting flange 12A is positioned over the vehicle's drawbar 18B. The flange 12A is positioned so that the flange's 12A hitchball shaft hole 16 is aligned over the hitchball shaft hole 16 of the vehicle's drawbar 18B. A hitchball's 22 threaded shaft 26 can then be inserted through the two hitchball shaft holes 16 in the mounting flange 12A and in the vehicle's drawbar 18B. A fastening nut 28 is then threaded onto the shaft 26 and tightened. This effectively binds the bracket assembly to the vehicle's towbar 18B.

Structural material 38A is then inserted into the brackets 10. Set screws 36 are then inserted through the set-screw holes 34 and into the structural material 38A, thus securing the structural material 38A into the brackets 10.

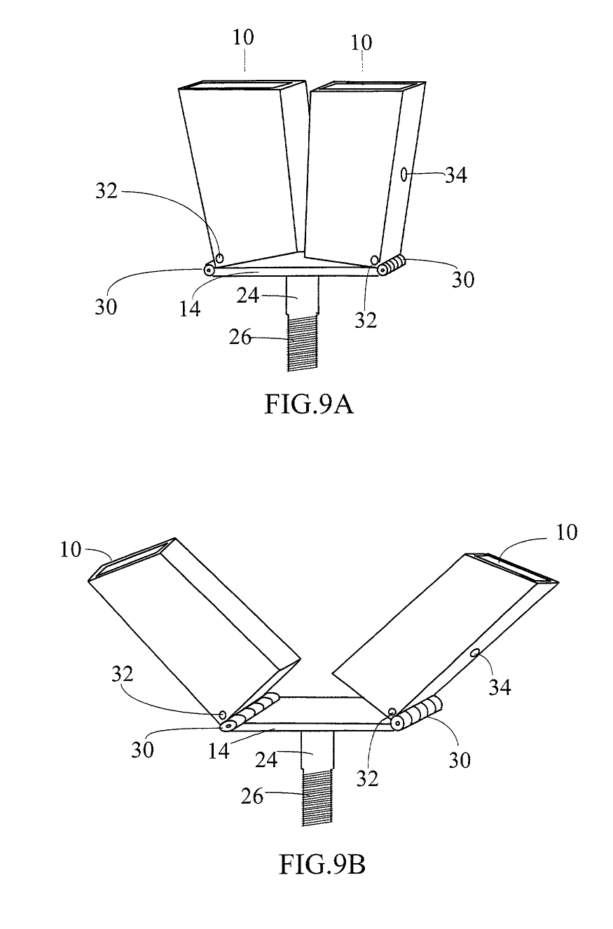

FIGS. 9A and 9B—Additional Embodiment

Two brackets 10 are connected to hinges 30. The other side of each hinge 30 is connected to a baseplate 14. The opposite face of baseplate 14 possesses a mounting shaft 24 that extends away from the baseplate 14. The shaft 24 is partially a threaded shaft 26. The brackets 10 possess drainage holes 32 near the baseplate 14. The brackets 10 possess set-screw holes 34 near the middle of one side of each bracket 10.

### OPERATION OF INVENTION

Attaching the Bracket Assembly to a Vehicle

This invention is a bracket assembly that is mounted to the rear of a vehicle, thereby rendering a base for a cargo carrying rack.

The first step in using the bracket assembly is to attach the bracket assembly to the carrier vehicle 40. The exact method for connecting the bracket assembly to a vehicle depends upon the specific configuration of the bracket assembly and the carrier vehicle. In the preferred embodiment (FIGS. 1, 8), the bracket assembly is positioned over the vehicle's towbar 18B. The flange 12A is positioned so that the flange's 12A hitchball shaft hole 16 is aligned over the hitchball shaft hole 16 of the vehicle's drawbar 18B. A hitchball's 22 threaded shaft 26 can then be inserted through the two hitchball shaft holes 16 in the mounting flange 12A and in the vehicle's drawbar 18B. A fastening nut 28 is then threaded onto the shaft 26 and tightened. This effectively binds the bracket assembly to the vehicle's towbar 18B. In FIG. 8 the orientation of the bracket assembly is such that the hitchball 22 is between the bracket receptacles 10 and the vehicle. It is also possible to turn the bracket assembly around 180 degrees so that the bracket receptacles 10 are between the hitchball 22 and the vehicle. This situation would require a longer drawbar 18B but would be advantageous when the user desires to use the hitch assembly to tow while the entire rack assembly 42 is mounted on the vehicle.

The embodiment of FIGS. 2, 3A, and 3B are attached to the vehicle in the same manner. In FIGS. 4, 9A, 9B, a baseplate 14 is used. The baseplate 14 possesses a threaded shaft 26 that can extend through a shaft hole 16 in a vehicle's drawbar 18. A fastening nut 28 is then threaded onto the shaft 26 and tightened. This effectively binds the bracket assembly to the vehicle's towbar 18A or 18B. The connection of the embodiments is shown in FIG. 8.

In FIGS. 5, 6, 7, the brackets 10 are connected directly to a drawbar 18A. The opposite end of the drawbar 18A is fitted to a vehicle via conventional means. Generally this is by inserting the drawbar 18A into a vehicle's hitch receiver box and then inserting a lock pin through the receiver box and through the hitch pin hole 20 in the drawbar 18A. This attaches the bracket assembly to the vehicle.

Some vehicles do not require the use of a drawbar 18A between the vehicle and the hitchball 22. On many of these vehicles, the hitchball 22 is attached directly to the bumper and fastened with a nut 28. On such vehicles, the bumper is substituted for the drawbar 18A. On such vehicles, the bracket assembly flange 12A, 12B can be sandwiched between the bumper and the hitchball 22 instead of between the drawbar 18A and the hitchball 22.

It is also possible for an embodiment to possess hardware that would allow it to be connected directly to a vehicle, such as by bolting the bracket assembly to the vehicle's frame.

Using the Bracket Assembly as the Base of a Cargo-Carrying Rack

Once the bracket assembly is attached to the vehicle, it renders a pair of receptacles that can be used as the base of a cargo carrying rack, to be completed by the user.

To complete the rack, the user inserts a length of structural material 38A into each of the two bracket receptacles 10, then attaches a third length of structural material 38B across the tops of the first two members. This third member 38B become the load bearing surface of the rack. The “structural material” usually will be commercially available wood such as “2 by 4s” but can be any strong material. Member 38B is attached to members 38A by conventional means such as screws, nuts and bolts, pegs, glue, etc.

Prior to installation, the user should cut the structural material 38A, 38B to a length so that the complete rack will serve its intended purposes well. For example, if the user desires to construct a rack that will support the back end of a canoe, (s)he should cut the material 38A so that the top 38B of the completed rack will be about the same height and width as the roof of the vehicle. This way, the cargo (a canoe) can be supported by the roof of the vehicle and the rear rack.

If the user desires to reduce any lateral swaying that the completed rack may exhibit, (s)he may tether the structural members 38A to the vehicle's bumper or to other suitable mounting points on the vehicle. This will reduce sway that is typically caused by gaps between the drawbar 18A, 18B and the vehicle's hitch receiver box.

Additional Information

I have described attaching the bracket assembly to the vehicle prior to completing the rack. In reality, it is probably easier to assemble the rack on a workbench or similar area, then attach the complete rack to the vehicle.

At the bottom of each bracket 10 is a drainage hole 32 through which water can drain when the entire bracket assembly is mounted on a vehicle. In many embodiments, the drainage holes could be located in the the baseplate 14 or the mounting flange 12A, 12B, 12C. A set-screw hole 34 is provided in the side of each bracket 10. A screw 36 is inserted through the set-screw hole 34 and into the structural material 38 to prevent the accidental removal of the structural material 38 from the bracket 10. It is also possible to provide two aligned set-screw holes on each bracket so that a user can pass a screw 36 or similar object through both sides of the bracket 10 and the structural material 38 that the bracket 10 holds.

### DESCRIPTION AND OPERATION OF ALTERNATE EMBODIMENTS

The bracket assembly can be made from a variety of materials, but structural metals are probably the best choice.

The drainage and set-screw holes can be located in a variety of places, including on the bottom of many of the described embodiments.

The method by which the device is attached to the vehicle is variable. In the preferred embodiment, the bracket assembly is permanently attached to a baseplate that extends beyond the bracket assembly. This baseplate has a hole in the protruding end. The baseplate is fitted between the vehicle's hitch's drawbar and the hitchball, with the shaft of the hitchball extending through the hole in the bracket assembly's baseplate.

Other viable methods to mount the bracket assembly include

Attaching the bracket assembly permanently to a drawbar that plugs into a vehicle's hitch receiver box

Providing apparatus as part of the bracket assembly that will clamp onto an existing hitch-mounted “ball”

Designing the mounting section of the bracket assembly so that it can be connected directly to a vehicle without the use of a hitch.

The angle between the brackets and the mounting part(s) can vary.

The angle between the brackets can vary.

The bracket assembly could include a hinge between the brackets and the mounting surface.

The bracket assembly could include hinges between the brackets.

The bottom of brackets could extend beyond the base, thereby negating the need for separate drainage holes.

The apparatus that connect the brackets to the vehicle can be connected to the brackets at a point that is higher than the bottom of the brackets. This would also negate the need for separate drainage holes.

The brackets can be sized to accept a variety of materials. The preferred embodiment is sized to accept standard “2 by 4” lumber (which is actually 1½×3½inches; approximately 38 by 89 mm), but the dimensions of the receptacles do not affect the novelty of the invention.

When used on pick-up trucks, station wagons, SUVs, or other vehicles without conventional trunks, the bracket assembly can me more useful if mounted with an extension between it and the vehicle's bumper area. This will allow the vehicle's doors and gates to function normally. The extension can be in the form of a longer mounting flange, longer drawbar, or the use of a supplementary extension piece.

It should be obvious that the bracket assembly can be used at the front end of a vehicle as well.

### CONCLUSION, RAMIFICATIONS, AND SCOPE OF INVENTION

Unlike any previous invention, the described bracket assembly provides a useful base for a vehicle-mounted triangular cargo rack. There have been many vehicle-mounted cargo racks over the years, but none has provided all of the benefits provided by my bracket assembly.

Comparing my bracket assembly to conventional rack assemblies is not fully appropriate. Prior art racks and various cargo-carrying devices are expressly complete racks, whereas my bracket assembly is simply a vehicle-mounted rack holding accessory. Thus any comparison between the two is immaterial.

My bracket assembly is not the first device created to hold two structural members. There are several devices that use bracket sets as the tops of structural legs. The most common occurrence of this is as sawhorse brackets. Numerous sawhorse leg brackets provide a means of connecting standard structural material together at their top ends, and may or may not provide a means for the attachment of another member (also at the top) that will be attached to another similar device at its other end.

It is obvious that my invention has some design features in common with sawhorse and similar brackets, however the uses and end-results of the two products are entirely different.

This invention is not the first use of connected brackets in general, but is the first use of brackets as the base of a vehicle mounted triangular rack system.

It should be obvious to one skilled in the field of either hitch-mounted vehicle accessories or in the field of paired bracket (especially sawhorse brackets) that the described vehicle-mounted bracket assembly will easily hold common structural material. The unexpected benefit of the bracket assembly is that it is the base of an entire rack system, providing an easy and safe method to carry cargo on a variety of vehicles.

The benefits of my bracket assembly are tightly linked to the benefits of the complete rack system for which it is the base.

Accordingly, the advantages of the present bracket assembly invention are:

The completed rack assembly is easy to mount-on and remove from a vehicle. This is due to the fact that with most embodiments, the rack is connected to the vehicle at only one point.

The completed rack assembly is inexpensive due to its use of commercial, user-supplied structural material such as lumber.

The completed rack assembly is stable due to its triangular geometry.

The completed rack assembly is customizable by the user. This is true because the user determines the final size of the rack by cutting the structural material to lengths appropriate for the rack's intended purpose. Also, due to the rack's use of commercial, user-supplied structural material such as lumber, it is easy to adapt the rack to specific cargo-it's easier to drill and shape wood than box steel.

The completed rack assembly is light-weight, again due to its use of commercial, user-supplied structural material such as lumber.

The completed rack assembly is durable.

The completed rack assembly is easy to disassemble. This is important because it allows the rack to be stowed in the carrying vehicle when use of the rack is not required. The ease of disassembling the rack depends upon the user's choice of equipment used to fasten the structural members together at the top of the completed rack.

The completed rack assembly does not appreciably interfere with the safety of the vehicle on which it is mounted. Any rear-mounted rack will affect the crash characteristics of the vehicle. A triangular rack based on the described bracket assembly will not block the corners of the vehicle as a quadrilateral rack would do. Therefore the triangular rack may be safer in certain circumstances. Unlike some racks, the triangular rack will not present a vertical blockage of the view from the vehicle's internal rear-view mirror, though it will interfere with some of the view from the inside of the vehicle.

The completed rack assembly can be used on a wide variety of motor vehicles, including cars, SUVs, and trucks.

Thus the described bracket assembly provides a rack device unlike any other.

Although the description above contains many specificities, these should not be construed as limiting the scope of the invention, but as merely providing illustrations of some of the currently preferred embodiments of the bracket assembly. For example, it is possible to equip the bracket assembly with different hinge, baseplate, and hole configurations. It is possible to change the dimensions and angles of many parts. It is possible vary the distance between the bracket arms.

Thus the scope of the invention should be determined by the appended claims and their legal equivalents rather than solely by the examples given.

I claim:

1. A bracket assembly comprising of:
a) Two hollow brackets, sized to hold conventional structural material, of sufficient length and strength so that any inserted structural material is firmly held, arranged relative to each other substantially like the letter ‘V.’
b) Some means of attaching the bracket assembly to a motor vehicle whereby when the bracket assembly is attached to a vehicle, the bracket receptacles are positioned approximately near the center of the bumper, on the side of the bumper opposite that of the majority of the vehicle, whereby the main openings of the receptacles are oriented substantially upward and toward the sides of the vehicle.

2. The device of claim 1 wherein the means of attachment to a motor vehicle is a flat bar that fits into a hitch receiver box and is secured with conventional hitch hardware, such as by extending a hitch pin through the hitch receiver box and the flat bar.

3. The device of claim 1 wherein the means of attachment to a motor vehicle is a tubular structure that fits into a hitch receiver box and is secured with conventional hitch hardware.

4. The device of claim 1 wherein the means of attachment to a motor vehicle is hardware that can be attached directly to the motor vehicle's frame with conventional hardware, such as bolts.

5. The device of claim 1 wherein the means of attachment to a motor vehicle is a flat flange that is attached to the bracket arms and contains a hole that allows the flange to be fitted between a standard hitchball and a vehicle's drawbar, with the shaft of the hitchball extending through the flange and the drawbar, whereby the flange is sandwiched between the base of the hitchball and the drawbar when a nut on the shaft of the hitchball is tightened.

6. The device of claim 1 wherein the means of attachment to a motor vehicle is a threaded shaft that extends downward from the bracket assembly, whereby the entire device can be mounted to a vehicle's drawbar by fitting the shaft through the drawbar and tightening a nut on the threads of the shaft.

7. The device of claim 1 wherein the device contains water drainage holes.

8. The device of claim 1 wherein the device contains holes whereby the structural members that are inserted into the receptacles may be secured by passing a shaft into the hole and into the structural material.

9. The device of claim 1 wherein the device contains one or more hinges whereby the angle between the bracket and the mounting apparatus may be varied.

10. The device of claim 1 wherein the device contains one or more hinges whereby the angle between the brackets may be varied.

11. A device comprised of
a) A first means of holding the bases of two structural members substantially together while said structural members are oriented substantially upward and outward from each other, substantially like the letter ‘V’
b) A second means of attaching the device to a motor vehicle, whereby when the device is attached to the motor vehicle, the device is held substantially near the center of the vehicle's bumper, and the geometric plane created by the ‘V’ of the two structural members is substantially vertical and parallel to the bumper.

12. The device of claim 11 wherein the means of attachment to a motor vehicle is a flat bar that fits into a hitch receiver box and is secured with conventional hitch hardware, such as by extending a hitch pin through the hitch receiver box and the flat bar.

13. The device of claim 11 wherein the means of attachment to a motor vehicle is a tubular structure that fits into a hitch receiver box and is secured with conventional hitch hardware.

14. The device of claim 11 wherein the means of attachment to a motor vehicle is hardware that can be attached directly to the motor vehicle's frame with conventional hardware, such as bolts.

15. The device of claim 11 wherein the means of attachment to a motor vehicle is a flat flange that is attached to the first means and contains a hole that allows the flange to be fitted between a standard hitchball and a vehicle's drawbar, with the shaft of the hitchball extending through the flange and the drawbar, whereby the flange is sandwiched between the base of the hitchball and the drawbar when a nut on the shaft of the hitchball is tightened.

16. The device of claim 11 wherein the means of attachment to a motor vehicle is a threaded shaft that extends downward from the first means, whereby the entire device can be mounted to a vehicle's drawbar by fitting the shaft through the drawbar and tightening a nut on the threads of the shaft.

17. The device of claim 11 wherein the device contains water drainage holes.

18. The device of claim 11 wherein the device contains holes whereby the structural members that are mounted to the device may be secured by passing shafts through the holes and into the structural members.

19. The device of claim 11 wherein the device contains one or more hinges whereby the angle between the supplementary structural members and the vehicle mounting means may be varied.

20. The device of claim 11 wherein the device contains one or more hinges whereby the angle between the structural members may be varied.
